(19) United States
(12) Patent Application Publication
(10) Pub. No.: US 2024/0025289 A1
(43) Pub. Date: Jan. 25, 2024

(54) SYSTEM AND METHOD FOR FULFILLING REQUESTS FOR ELECTRIC ENERGY SERVICES

(71) Applicant: HYLIION INC., Cedar Park, TX (US)

(72) Inventor: Megan Wooley, Austin, TX (US)

(21) Appl. No.: 18/308,163

(22) Filed: Apr. 27, 2023

Related U.S. Application Data
(60) Provisional application No. 63/336,085, filed on Apr. 28, 2022.

(51) Int. Cl. B60L 53/63; B60L 53/64

(52) U.S. Cl. CPC B60L 53/63; B60L 53/64

(57) ABSTRACT

Systems and methods for responding to service requests for electric energy services are disclosed. When a customer communicates a service request, embodiments determine how many mobile resources are needed to fulfill the service request. Embodiments identify one or more mobile resources that may be available to fulfill the service request and determine, for each mobile resource, one or more of an expected revenue, a return on investment and an incentive for selecting one or more mobile resources to respond to the service request. Embodiments determine a price corresponding to the one or more selected mobile resources responding to the service request and communicate at least one price option to the customer. When the customer selects a price option, embodiments communicate a route, a performance plan, and an energy service supply plan to each selected mobile resource to fulfill the customer's service request.

### BENEFIT CLAIM

This application claims the benefit of provisional application 63/336,085, filed Apr. 28, 2022, the entire contents of which are hereby incorporated by reference for all purposes as if fully set forth herein.

### BACKGROUND

### Field of the Disclosure

This disclosure relates generally to providing mobile resources to respond to requests for electric energy services and, more particularly, to selecting one or more mobile resources for responding to a request for electric energy service, determining a performance plan and an energy service supply plan for each mobile resource, and communicating with and managing the operation of one or more selected mobile resources capable of generating, storing and supplying electric energy service to a customer associated with an external electric system.

### Description of the Related Art

As used herein, the term “electric vehicle” (or “EV”) may refer to a vehicle used to transport people with small amounts of luggage or cargo. EVs typically have a range between 50-200 miles when new, but the range diminishes as the batteries age and is based on the number of charge/discharge cycles. EVs typically carry up to about 1000 pounds including the driver and recharge at designated charging stations.

As used herein, the term “facility” may refer to any commercial or government building or structure that uses electricity. A hospital, a restaurant, and a campus are examples of facilities. Almost all facilities get electric energy service from an interconnected network of power-generating facilities, substations, transformers, high-voltage lines, wires, and other equipment collectively referred to as the grid. Some facilities may have generators or other backup electrical power sources in the event electric power service from the grid is interrupted, such as during a hurricane or other natural event.

As used herein, the term “agency” may refer to an organization responsible for distributing electric energy services for an area. An agency may include a government or office specifically tasked with providing electric energy services, which may include generating electric power or buying electric power. An area may be associated with a city, a state or a region spanning multiple states.

As used herein, the term mobile resource may refer to any vehicle that can generate, store, and supply electric power and/or electric services (which may be used to fulfill a request for electrical energy services). Large, wheeled vehicles such as trucks may be used to efficiently transport cargo and be capable of traveling over routes that include a wide range of surfaces from dirt paths in remote areas to concrete roads in urban settings. Wheeled vehicles generally comprise a chassis having a front axle and two rear axles, wherein one rear axle is a drive axle, and the other rear axle supports a portion of the truck weight. Examples of wheeled vehicles include box trucks in which a cab is attached to a cargo compartment, a bus in which the driver area is integrated with a passenger compartment, and a semi-tractor (also referred to as a semi, a tractor, or a truck) that is configured for coupling to a trailer comprising the cargo compartment (wherein the combination may be referred to as a tractor-trailer). Wheeled vehicles, particularly tractor-trailers, transport large volumes of cargo on land, wherein the combination of the tractor and the trailer can weigh between 30,000 pounds empty up to 140,000 pounds for a tandem loaded trailer. In many of these vehicles, a drivetrain comprises an engine coupled to the drive axle. Traditionally, an internal combustion engine that may be sized in the range of 15 liters generates rotational power to drive the tractor-trailer over various routes with various surfaces and on varying grades.

### SUMMARY

The appended claims may serve as a summary of the invention.

Mobile resource industries are in a unique position to respond to changes in the electric power industry and transportation industry. The push to electrify across transportation, businesses, and industries is introducing unique opportunities to interact with the grid.

Embodiments disclosed herein may interact with one or more mobile resources capable of generating, storing, and delivering electric energy service to a customer requesting electric energy service.

A mobile resource may be a hybrid electric vehicle, such as a hybrid electric truck or a hybrid electric truck/trailer combination, or a fully electric vehicle such as a fully electric truck or a fully electric truck/trailer combination. Mobile resources include but are not limited to other wheeled vehicles as well as vehicles associated with gensets and other mobile systems capable of generating and/or storing electric power and may include watercraft and aircraft. The customer may be associated with an electric vehicle needing electricity to reach a destination, a facility (which may be a single building or a group of buildings associated with an institution), or an agency (which may include a government responsible for a grid or otherwise supplying electric power or electric services to an area having multiple facilities). A customer may request electric energy services to support a grid and/or may specify an amount of electric energy service and/or frequency regulation of electric energy service.

An aggregate of mobile energy resources can mobilize quickly and operate in the capacity market to provide electric energy service in the event of system emergencies. Individual energy service vehicles can operate as mobile resources in real-time energy markets and ancillary markets. For example, if the benefits of the hybrid and electric truck industry are combined with the needs of the electric energy service industry, there exists a new business case for fleet managers. Managing resource proximity to a connection point and assessing the risk of a capacity request poses a challenge to operating in the capacity market.

Embodiments described herein may be directed to systems and methods that enable mobile resources such as vehicles to mobilize quickly and operate in various markets to supply electric energy as a service (EaaS). Embodiments constantly analyze data related to mobile resources, fleets, grids, and environmental conditions to assess the likelihood of a capacity event and the capability to select and aggregate mobile resources in time.

Embodiments may minimize impacts on normal mobile resource operations while maximizing capacity request readiness. In different states of readiness, embodiments communicate actions to take in response to a service request. Embodiments may interact with a person acting as a bid manager or may automate a process for negotiating the use of mobile resources with wholesale electricity markets and other parties that own the mobile resources. Embodiments enable mobile resources (individually or as fleets) to operate and earn revenue in real-time energy markets and more challenging capacity markets.

Embodiments described herein may receive a service request for energy from a customer, wherein the customer may be associated with an electric vehicle, a facility, or an agency responsible for providing electric energy services to a group of electricity users in an area. A response to the service request may be generated within a short time. For example, embodiments may receive a service request, determine how many mobile resources are needed to fulfill the energy service request, identify a set of mobile resources, and generate a response to the energy service request for electrical energy service within seconds or a few minutes.

Some mobile resources described herein include trucks and other wheeled vehicles with a hybrid drivetrain comprising an engine operable to generate rotational power, one or more motor/generators (M/Gs), a battery system and a controller communicatively coupled to sensors, an Engine Control Module (ECM), a Transmission Control Module (TCM), a Motor Control Module (MCM) and a Battery Control Module (BCM). The controller executes drivetrain configuration instructions to configure the drivetrain, which may include powering up or powering down the engine, and/or signaling a motor/generator (M/G) to operate as a motor or as a generator, signaling a battery system to enable charging or discharging. Vehicles may have unique drivetrains with one of several different types of engines, M/Gs, and battery systems, with each drivetrain being configurable to propel the vehicle along a route and/or generate electric power to supply to an external electric system. Each drivetrain may be configurable for transporting the same cargo weight over the same route but may operate under different operating parameters.

Each motor/generator (M/G) can be configured as a motor to receive electric power and generate rotational power or be configured as a generator to receive rotational power, such as rotational power received from the drivetrain components during regenerative braking, and generate electric power.

In some embodiments, the engine is directly coupled to a first M/G, wherein operating the engine supplies rotational power to the first M/G operating as a generator to generate electric power. Electric power generated by the first M/G may be supplied to the battery system to charge the battery system and/or supplied to the second M/G coupled to an electric drive axle and/or supplied to an external electric system.

Embodiments may be generally directed to a method for responding to a service request for electric energy service with one or more mobile resources, the method comprising receiving a service request for electric energy service over a network, determining the number of mobile resources needed to fulfill the service request, identifying one or more mobile resources available to fulfill the service request from a plurality of mobile resources, selecting one or more mobile resources from the identified one or more mobile resources to fulfill the service request, and communicating, to each selected mobile resource, a route to travel to a service request location, a performance plan to manage the operation of a drivetrain to travel to the service request location, and an energy service supply plan to manage the operation of the drivetrain to supply the electric energy service at the service request location to fulfill the service request.

In some embodiments, the service request comprises one or more of the amount of the electric energy service to be supplied, a rate at which the electric energy service is to be supplied, a time duration during which the electric energy service is to be supplied and a characteristic of the electric energy service and one or more of customer identification, the service request location, and a time. In some embodiments, determining the number of mobile resources comprises determining a mobile resource capable of supplying the electric energy service based on one or more of the amount of electric energy service, the rate at which the electric energy service is to be supplied, the time duration during which the electric energy service is to be supplied and the characteristic of the electric energy service.

In some embodiments, the plurality of mobile resources comprises at least one of: a hybrid electric truck, a hybrid electric truck/trailer combination, a fully electric truck, or a fully electric truck/trailer combination.

In some embodiments, the method further comprises determining a price option for the identified one or more mobile resources to fulfill the service request, wherein determining the price option comprises determining one or more of an amount of revenue, a return on investment (ROI), and an incentive to responding to the service request.

In some embodiments, determining the price option for the identified one or more mobile resources to fulfill the service request comprises, for each mobile resource of the identified one or more mobile resources, determining a set of detour routes to travel to the service request location, determining a revenue associated with the mobile resource traveling to the service request location for each detour route of the set of detour routes, determining a return on investment (ROI) associated with the mobile resource traveling to the service request location for each detour route of the set of detour routes and determining an incentive associated with the mobile resource traveling to the service request location for each detour route of the set of detour routes.

In some embodiments, determining the set of detour routes for each mobile resource of the identified one or more mobile resources comprises determining an original route for the mobile resource between an original route start point and an original route endpoint, determining a present location of the mobile resource, determining a first portion of a first detour route with a first detour route start point corresponding to the original route start point, determining a first portion of a second detour route with a second detour route start point corresponding to the present location of the mobile resource, and determining a first portion of a third detour route with a third detour route start point between the present location of the mobile resource and the service request location.

In some embodiments, determining the revenue for each detour route in the set of detour routes comprises determining a first amount of revenue for supplying electric energy service at the service request location and, for each detour route, determining a second amount of revenue for traveling over the detour route and adding the first amount of revenue to the second amount of revenue.

In some embodiments, determining a return on investment for each detour route in the set of detour routes comprises determining a first time duration for supplying electric energy service at the service request location and, for each detour route, determining a second time duration for traveling over the detour route and dividing the first time duration by the second time duration.

In some embodiments, the incentive comprises one or more of a revenue or cost reduction earned for responding to the service request within a specified time duration, a revenue or cost reduction earned for supplying an amount of electric energy service more than a threshold amount specified in the service request, a revenue or cost reduction earned for supplying electric energy service at a rate greater than a threshold rate specified in the service request, and a revenue or cost reduction earned for supplying electric energy service for a time duration longer than a threshold time duration specified in the service request.

In some embodiments, the method further comprises changing a configuration of a drivetrain in a selected mobile resource in response to the set of drivetrain configuration instructions received at the selected mobile resource.

In some embodiments, communicating to each selected mobile resource, the performance plan for the selected mobile resource to travel to the service request location comprises determining a present location of the mobile resource, determining a plurality of segments for a route to travel from the present location of the mobile resource to the service request location, for each segment: determining a set of starting values for a set of operating parameters for the mobile resource, the set of starting values comprising a starting state of charge (SOC) for a battery system and a starting fuel quantity at a start of the segment, determining a starting drivetrain configuration of the mobile resource, determining a set of target values for the plurality of operating parameters, the set of target values comprising a target SOC for the battery system and a target fuel quantity at an end of the segment, calculating, based on the set of starting values and the starting drivetrain configuration, a set of predicted end values for the plurality of operating parameters, the set of predicted end values comprising a predicted end SOC of the battery system and a predicted fuel quantity at the end of the segment and determining one or more predicted end values of the set of predicted end values will be less than one or more target values of the set of target values, and communicating the performance plan comprising the set of target values for the set of operating parameters and a set of drivetrain configuration instructions to change the drivetrain configuration.

In some embodiments, communicating to each selected mobile resource, the performance plan for the selected mobile resource to travel to the service request location comprises determining the predicted end SOC of the battery system will be less than a target SOC of the battery system and communicating the performance plan comprising the set of drivetrain configuration instructions to change the drivetrain configuration to charge the battery system and the set of target values for the set of operating parameters comprises the target SOC for the battery system.

In some embodiments, communicating to each selected mobile resource, the performance plan for the selected mobile resource to travel to the service request location comprises determining the predicted fuel quantity will be less than the target fuel quantity and communicating the performance plan comprising the set of drivetrain configuration instructions to change the drivetrain configuration to not operate an engine over the segment and supply electric energy service from the battery system to a motor/generator to propel the mobile resource on the segment.

In some embodiments, the method comprises filtering the identified one or more mobile resources available to fulfill the service request to identify a set of mobile resources to respond to the service request, communicating a resource request to each mobile resource in the set of mobile resources, receiving a response from at least one mobile resource in the set of mobile resources, determining a set of price options for the at least one mobile resource to fulfill the service request, comprising determining a set of detour routes for a mobile resource in the set of mobile resources to travel to the service request location and determining a price option based on a cost associated with the mobile resource traveling to the service request location for each detour route and communicating the set of price options to a customer over the network.

In some embodiments, determining the number of mobile resources comprises comparing an amount, rate, or duration of electrical energy service supply in the service request to an amount of electrical energy service supply available from a fleet of mobile resources.

In some embodiments, identifying the one or more mobile resources available to fulfill the service request comprises determining the service request location and determining a proximity of available mobile resources to the service request location.

In some embodiments, the method further comprises supplying the electric energy service at the service request location via the selected one or more mobile resources according to the energy service supply plan.

Embodiments may be generally directed to a system for responding to a service request for electric energy service, comprising an operations server. The operations server executes instructions to receive the service request over a network, determine a number of mobile resources needed to fulfill the service request, identify at least one mobile resource available to fulfill the service request, select one or more mobile resources from the at least one mobile resource to fulfill the service request based on a selected price option and communicate, to each mobile resource of the selected one or more mobile resources, a route to travel to a service request location, a performance plan to manage the operation of a drivetrain to travel to the service request location, and an energy service supply plan to supply the electric energy service at the service request location.

In some embodiments, the energy service request comprises one or more of an amount of the electric energy service to be supplied, a rate at which the electric energy service is to be supplied, a time duration during which the electric energy service is to be supplied, and a characteristic of the electric energy service and one or more of a customer identification, the service request location, and an energy service, wherein the operations server stores instructions executable to determine the number of mobile resources capable of supplying electric energy service based on one or more of the amount of the electric energy service, the rate at which the electric energy service is to be supplied, the time duration during which the electric energy service is to be supplied and the characteristic of the electric energy service.

In some embodiments, the operations server executes instructions to determine one or more of an amount of revenue, a return on investment (ROI), and an incentive to respond to the service request.

In some embodiments, the operations server stores instructions executable to, for each mobile resource of the identified at least one mobile resource, determine a revenue associated with the mobile resource traveling to the service request location for each detour route of a set of detour routes, determine a return on investment (ROI) associated with the mobile resource traveling to the service request location for each detour route of the set of detour routes, and determine an incentive associated with the mobile resource traveling to the service request location for each detour route of the set of detour routes.

In some embodiments, the system further comprises a route planning server communicatively coupled to the operations server, wherein the route planning server stores instructions executable to, for each mobile resource of the identified at least one mobile resource, communicate with the operations server to get an original route start point and an original route endpoint, determine an original route for the mobile resource between the original route start point and the original route endpoint, determine a present location of the mobile resource, determine a first portion of a first detour route with a first detour route start point corresponding to the original route start point, determine a first portion of a second detour route with a second detour route start point corresponding to the present location of the mobile resource, and determine a first portion of a third detour route with a third detour route start point between the present location of the mobile resource and the service request location.

In some embodiments, to determine the revenue for each detour route in the set of detour routes, the operations server executes instructions to determine a first amount of revenue for supplying electric energy service at the service request location and, for each detour route, determine a second amount of revenue for traveling over the detour route and add the first amount of revenue to the second amount of revenue.

In some embodiments, to determine the return on investment for each detour route in the set of detour routes, the operations server executes instructions to determine a first time duration for supplying electric energy service at the service request location and, for each detour route, determine a second time duration for traveling over the detour route and divide the first time duration by the second time duration.

In some embodiments, to determine an incentive, the operations server executes instructions to determine a revenue or cost reduction earned for responding to the service request within a specified time duration, determine a revenue or cost reduction earned for supplying an amount of electric energy service more than a threshold amount specified in the service request, determine a revenue or cost reduction earned for supplying electric energy service at a rate greater than a threshold rate specified in the service request, and determine a revenue or cost reduction earned for supplying electric energy service for a time duration longer than a threshold time duration specified in the service request.

In some embodiments, to communicate the performance plan to each mobile resource of the selected one or more mobile resources, a route planning server executes instructions to determine a present location of the mobile resource and determine, for each detour route of a set of detour routes, a plurality of segments for the detour route. For each segment, a mobile resource configuration server communicatively coupled to the operations server executes instructions to determine a set of starting values for a set of operating parameters for the mobile resource, the set of starting values comprising a starting state of charge (SOC) for a battery system and a starting fuel quantity at a start of the segment, determine a starting drivetrain configuration of the mobile resource, determine a set of target values for the set of operating parameters, the set of target values comprising a target SOC for the battery system and a target fuel level at an end of the segment, calculate, based on the set of starting values and the starting drivetrain configuration, a set of predicted end values for the set of operating parameters, the set of predicted end values comprising a predicted end SOC of the battery system and a predicted fuel quantity at the end of the segment; and determine one or more predicted end values of the set of predicted end values will be less than one or more target values of the set of target values. The operations server communicates the performance plan comprising the set of target values for the set of operating parameters and a set of drivetrain configuration instructions to change the drivetrain configuration.

In some embodiments, the operations server stores instructions executable to filter the identified at least one mobile resource available to fulfill the service request to identify a set of mobile resources to respond to the service request communicate a resource request to each mobile resource in the set of mobile resources receive a response from at least one mobile resource in the set of mobile resources determine a set of price options for the at least one mobile resource to fulfill the service request, comprising: determine a set of detour routes for a mobile resource in the set of mobile resources to travel to the service request location and determine a price option based on a cost associated with the mobile resource traveling to the service request location for each detour route, and communicate the set of price options to a customer over the network.

In some embodiments, to determine the number of mobile resources, the operations server executes instructions to compare an amount, rate, or duration of electrical energy service supply in the service request to an amount of electrical energy service supply available from a fleet of mobile resources.

In some embodiments, to identify at least one mobile resource available to fulfill the service request, the operations server executes instructions to determine the service request location, and determine a proximity of available mobile resources to the service request location.

### BRIEF DESCRIPTION OF THE DRAWINGS

For a more complete understanding of the present invention and its features and advantages, reference is now made to the following description, taken in conjunction with the accompanying drawings, in which:

FIG. 1 depicts a block diagram illustrating components in a system for responding to a service request for electric energy service;

FIG. 2 depicts a flow diagram of a method for responding to a service request for electric energy service;

FIG. 3 depicts a flow diagram illustrating a method for selecting a mobile resource for responding to a service request for electric energy service;

FIG. 4 depicts a flow diagram illustrating a method for selecting a set of mobile resources for responding to a service request for electric energy service;

FIG. 5 depicts a flow diagram illustrating a method for selecting a set of mobile resources for responding to a service request for electric energy service;

FIG. 6 depicts a table, illustrating a data structure containing drivetrain configuration instructions and values for a set of operating parameters for a mobile resource according to an energy service supply plan; and

FIG. 7 depicts a table, illustrating a data structure containing drivetrain configuration instructions and values for a set of operating parameters for a mobile resource according to a performance plan.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, embodiments are described as they pertain to mobile resources such as large, wheeled vehicles having a hybrid drivetrain comprising an engine (which may be powered by diesel, hydrogen, RNG, and/or CNG, and in some embodiments may be a fuel agnostic engine or a hydrogen fuel cell), a drive axle coupled to the engine, two motor/generators (M/Gs) configurable as a motor or a generator, a battery system comprising a plurality of batteries and an electric drive axle coupled to one of the M/Gs. An engine control module (ECM) may receive inputs from a driver and a plurality of sensors and adjust operation of the engine based on the driver input. A transmission controller may communicate with sensors or the ECM to get values for the operating parameters of the engine and execute instructions to control the operation of a transmission coupled to a first drive axle. A M/G controller may communicate with sensors, the ECM, and the transmission controller and execute instructions to determine when to operate a M/G as a motor or operate the M/G as a generator. A battery management system may monitor a battery system to determine when the battery system can supply electric energy service, when the battery system needs charging, and when the battery system cannot or should not supply electric energy service or receive electric energy service. Embodiments may also pertain to other wheeled vehicles with two or more axles that are capable of generating, storing, and supplying electric energy service. Mobile resources may have one or more available connection points utilized to connect to the customer's vehicle or the location through which the electrical energy service or electrical power is delivered to the customer to fulfill the service request.

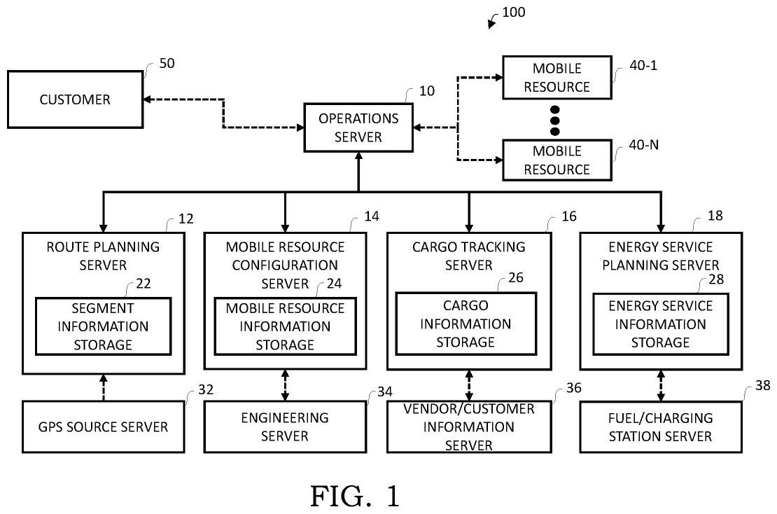

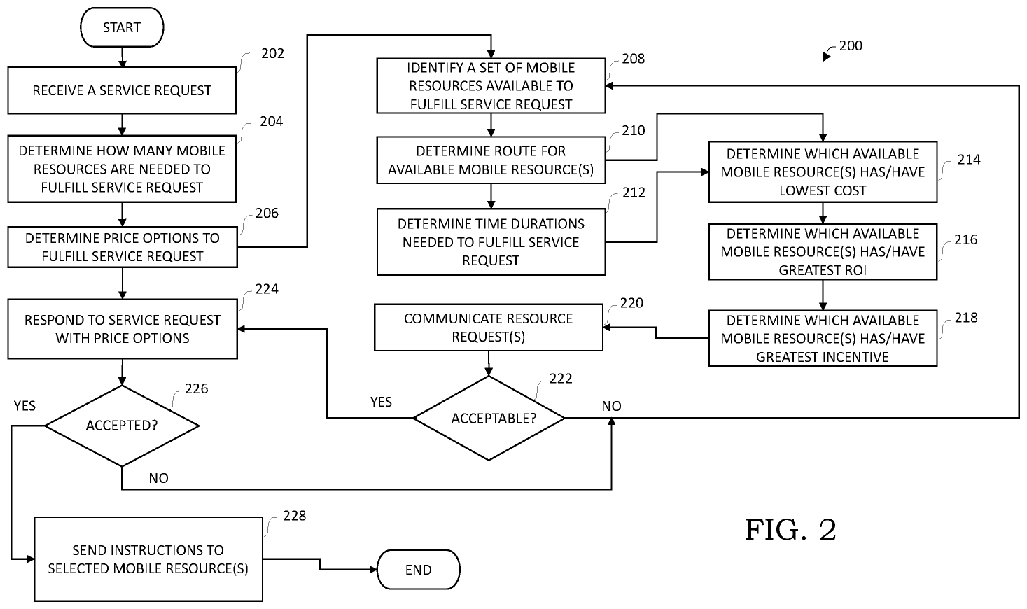

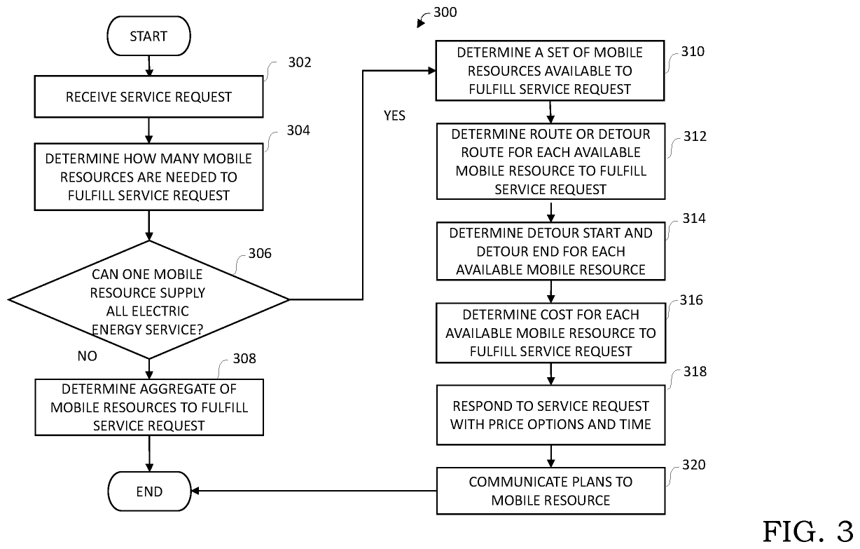

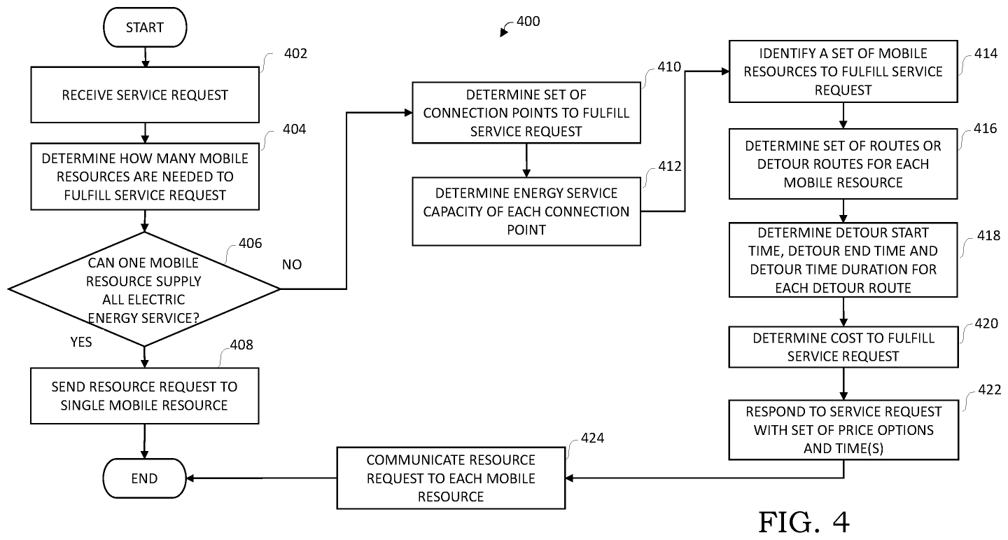

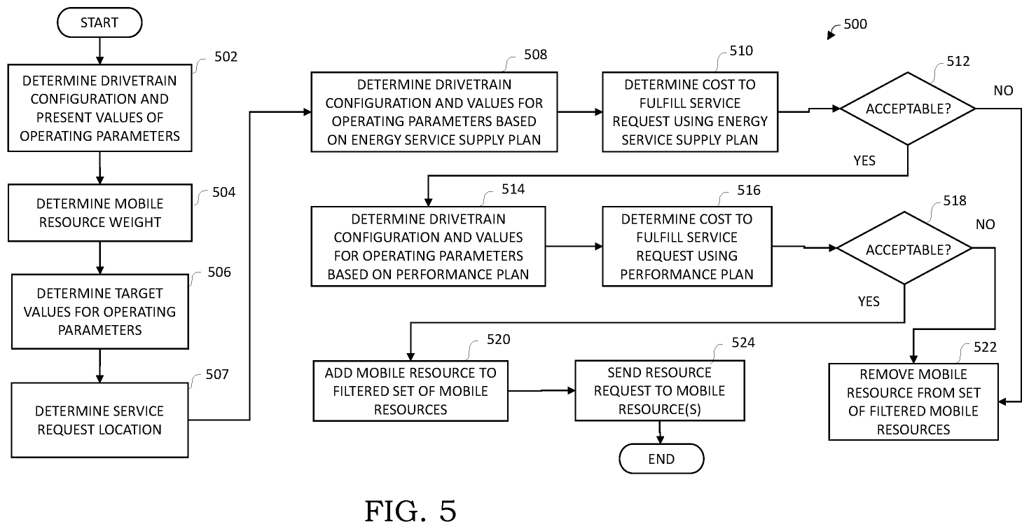

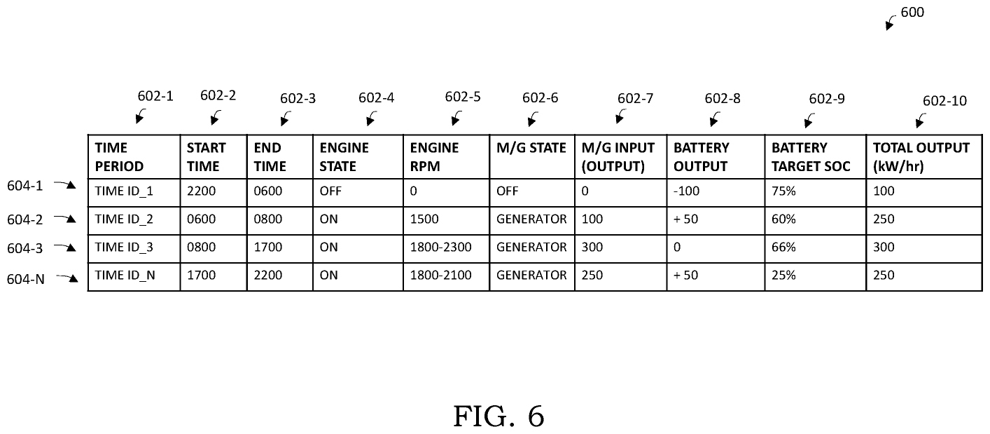

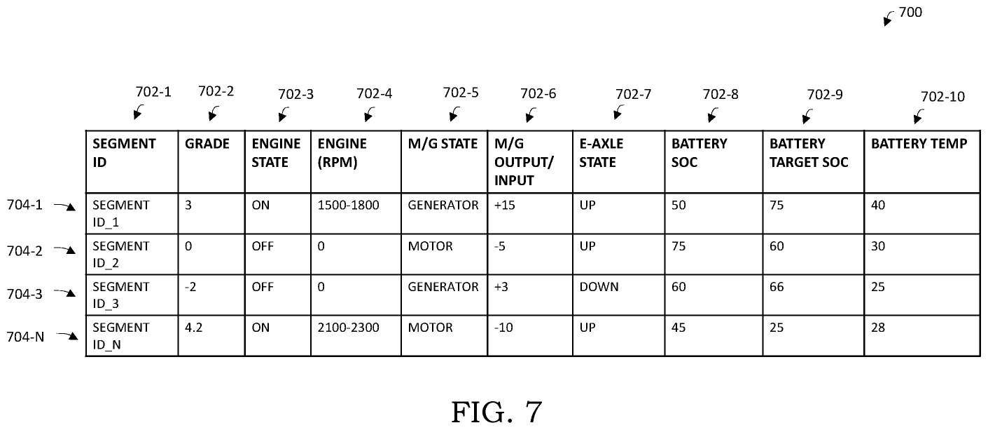

Particular embodiments may be best understood by reference to FIG. 1, FIG. 2, FIG. 3, FIG. 4, FIG. 5, FIG. 6, FIG. 7, wherein like numbers are used to indicate like and corresponding parts.

System Overview

Turning now to the drawings, a system 100 for responding to a request for electric energy service from a customer 50 may include an operations server 10 communicatively coupled to route planning server 12, mobile resource configuration server 14, cargo tracking server 16, and energy service planning server 18. Operations server 10 may also communicate with one or more mobile resources 40 (e.g., 40-1 to 40-N) to receive information about a particular mobile resource 40 and/or send a performance plan to a mobile resource 40 corresponding to a route used to fulfill the service request and send an energy service supply plan to the mobile resource 40 corresponding to supplying electric energy service at a stopover location. Communication between operations server 10 and customer 50, mobile resources 40, route planning server 12, mobile resource configuration server 14, cargo tracking server 16 and energy service planning server 18 may be over a network.

Operations server 10 processes information associated with operations of mobile resources 40 of an enterprise, including managing costs associated with transporting cargo loads and managing the pickup of a cargo load from a route start point and delivering the cargo load to a route endpoint.

Route planning server 12 communicates with operations server 10 to get route planning information associated with a mobile resource 40. The route planning information may include an original route start point and an original route endpoint for a route associated with mobile resource 40. Route planning server 12 may communicate with a global positioning system (GPS) source server 32 to retrieve route data between the route start point and the route endpoint, analyze the route data and store the analyzed route data in segment information storage 22. Route planning server 12 may communicate the results of any analysis to operations server 10 or mobile resource 40. When a service request is received from customer 50, route planning server 12 may communicate with operations server 10 and/or a mobile resource 40 to get a present location and an original route for the mobile resource 40. Route planning server 12 may determine, based on the present location and a stopover location determined from the service request, a first portion of a detour route between a first portion start point and a first portion endpoint, and a first portion time duration between a first portion start time and a first portion end time. Route planning server 12 may determine, based on the stopover location and the original route destination location, a second portion of the detour route between a second portion start point and a second portion endpoint, and a second portion time duration between a second portion start time and a second portion end time.

Mobile resource configuration server (e.g., drivetrain configuration server) 14 may communicate with operations server 10, engineering server 34, and a set of mobile resources 40 to get present drivetrain configuration information about a drivetrain in each mobile resource 40. Mobile resource configuration server 14 may communicate with engineering server 34 to get values for operating parameters for each mobile resource 40. For example, engineering server 34 may store drivetrain configuration information such as a type of engine installed in a mobile resource 40 and values for operating parameters for the engine such as an engine displacement, a type of fuel used by the engine, and a range of operating speeds of the engine. Mobile resource configuration server 14 may also communicate with mobile resource 40 to get present drivetrain configuration information and present values for a set of operating parameters for the drivetrain in mobile resource 40. In some embodiments, when a mobile resource 40 energy services up, mobile resource 40 communicates present drivetrain configuration information to mobile resource configuration server 14. Drivetrain configuration information may include information that does not change regularly, such as a vehicle base weight and a chassis type and may also include information that can change frequently, such as a fuel level and a battery state of charge (SOC). Drivetrain configuration information may be stored in mobile resource information storage 24 and/or communicated to memory in mobile resource 40.

Cargo tracking server 16 communicates cargo load information to operations server 10. Cargo load information may include the type of cargo, a weight, any information specific to the cargo load (e.g., if a cargo load requires refrigeration, if there is a hazardous material, if the cargo load must be delivered by a deadline, etc.). In some embodiments, cargo tracking server 16 may communicate with cargo information storage 26 to get cargo load information. In some embodiments, cargo tracking server 16 may communicate over a network with vendor/customer information servers 36 associated with vendors, merchants, or other external parties to get cargo load information. Cargo tracking server 16 may update cargo load information in cargo information storage 26.

Energy service planning server 18 communicates with operations server 10 or route planning server 12 to get route information about a route over which a mobile resource 40 is expected to travel and uses the route information to identify a set of fuel stations and charging stations along the route and identify one or more locations where fuel can or should be acquired or charging can or should occur. In some embodiments, energy service planning server 18 communicates over a network with fuel/charging station server 38 to get fuel/charging information associated with third parties (external sources) or associated with warehouses or other internal sources. Energy service planning server 18 may get information about fuel costs, a wait time for the availability of a pump, the number of pumps at a fuel station, an energy service cost (including variations in cost due to peak demand, off demand, holiday and weekday or weekend rates), a wait time for availability for a charging station, a number of charging stations and a rate at which charging can occur, and may store the information in energy service information storage 28.

Operations server 10 may communicate with other systems as well. For example, operations server 10 may communicate with a warehouse server to determine the average time a mobile resource 40 stays at the warehouse, communicate with a traffic server to identify traffic or traffic patterns, communicate with a weather server to get updates on weather and communicate with a satellite imagery server to get information about a route.

In some embodiments, operations server 10 communicates instructions to one or more of route planning server 12, mobile resource configuration server 14, cargo tracking server 16, energy service planning server 18, GPS source server 32, engineering server 34, vendor/customer information server 36 and fuel/charging station server 38 to collect information including a drivetrain present configuration and present values for a set of operating parameters, wherein operations server 10 performs calculations on the collected information, executes processes to determine a drivetrain configuration and target values for a set of operating parameters for one or more mobile resources 40 and communicates a set of drivetrain configuration instructions and target values for a set of operating parameters to each mobile resource 40.

In some embodiments, operations server 10 may communicate instructions to one or more of the route planning server 12, mobile resource configuration server 14, cargo tracking server 16, energy service planning server 18, GPS source server 32, engineering server 34, vendor/customer information server 36 and fuel/charging station server 38 to perform the calculations, execute the processes for determining a drivetrain configuration and values for a set of operating parameters for a mobile resource 40, and communicate the set of drivetrain configuration instructions and values for a set of operating parameters for each mobile resource 40 to operations server 10, wherein operations server 10 communicates the set of drivetrain configuration instructions and values for the set of operating parameters to the mobile resource 40.

Responding to a Service Request

FIG. 2 depicts a flow diagram, illustrating a method 200 for responding to a service request. Steps in method 200 may be performed by one or more of the operations server 10, route planning server 12, mobile resource configuration server 14, cargo tracking server 16, and energy service planning server 18 executing instructions and communicating with customer 50 and mobile resource 40.

At step 202, a service request is received from customer 50. The service request may include a service request location and an amount of requested electric energy service, a rate at which the electric energy service is to be supplied, a time duration for supplying electric energy service, or a characteristic of the supplied electric energy service. In some situations, a customer 50 may be an EV that is moving but has a low battery SOC, wherein embodiments may determine the service request location based on a route the EV is traveling and how fast the EV is moving and searching along the route for any possible locations (e.g., a restaurant parking lot, a rest stop, etc.) where a mobile resource 40 may be able to meet the EV. The service request may include characteristics about the electric energy service, including specifying that the electric energy service should be supplied at a lower voltage (e.g., 12V) or supplied as direct current (DC). In some situations, a customer 50 may be a facility with one or more connection points, wherein embodiments may identify a service request location based on connection point location information stored in memory accessible by operations server 10 or energy service planning server 18. The service request may include characteristics about the electric energy service, including specifying that the electric energy service should be supplied at a common voltage (e.g., 110 V), supplied as alternating current (AC), or that the electric energy service should be supplied at a first rate (e.g., 200 kW/hour) during business hours but a lower rate (e.g., 100 kW/hour) during evening hours. In some situations, a customer 50 may be an agency, wherein embodiments may identify a plurality of service request locations based on connection point location information stored in memory accessible by operations server 10 or energy service planning server 18. The service request may include characteristics about the electric energy service, including specifying that the electric energy service should be supplied at a common voltage (e.g., 110 V), supplied as alternating current (AC), or that a minimum amount of electric energy service (e.g., 10 MW) should be supplied for a time duration.

In some situations, a service request may indicate an amount of electric energy service. In some situations, customer 50 may communicate a service request for electric energy service and embodiments may determine the amount of energy service needed. For example, customer 50 driving an EV may communicate a service request for electric energy service along with a present location, a present speed, and a destination location or a route. The customer might not know how much electric energy service is needed or may provide an estimate (e.g., 5 kW). Embodiments may communicate with the EV to determine a destination (including address information) and EV information (e.g., present weight, efficiency, battery state-of-health, etc.), determine the route the EV is traveling on, determine traffic and weather conditions along the route and determine the EV needs more energy service (e.g., 8 kW) to reach the destination.

At step 204, embodiments may determine how many mobile resources 40 are needed to fulfill the service request. The number of mobile resources 40 may depend on the amount of electric energy service needed when it is needed, how much time is needed to provide the electric energy service, characteristics of the electric energy service, etc.

At step 206, embodiments determine a set of price options to fulfill the service request. Determining a price option may comprise determining the quantity or duration of an energy service (e.g., a market price earned by supplying the electric energy service) and may include any costs needed to supply the electric energy service (e.g., a cost of fuel for mobile resource 40 to provide the amount of electricity requested, the labor cost of an operator of a mobile resource 40), and other costs.

At step 208, embodiments may identify a set of available mobile resources 40 to fulfill the service request. Not every mobile resource 40 will be available to fulfill every service request. The set of mobile resources 40 available to fulfill the service request may include more mobile resources 40 than the number of mobile resources 40 needed to fulfill the service request to allow selection of a mobile resource 40 or set of mobile resources 40 best suited for fulfilling the service request. For example, embodiments may determine only one mobile resource 40 is needed to fulfill a service request but may identify multiple mobile resources 40 that may be available to fulfill the service request. Identifying a set of mobile resources 40 available to fulfill a service request allows embodiments to determine which mobile resource 40 (or mobile resources 40) may be preferred due to customer preference or mobile resource operator preference, described below.

A mobile resource 40 might be unavailable for various reasons, such as if it is transporting cargo, is transporting cargo with a deadline, or is traveling to a destination for maintenance. In some embodiments, operations server 10 may communicate with mobile resource configuration server 14, engineering server 34, cargo tracking server 16, and a set of mobile resources 40 to get information about the set of mobile resources to determine which mobile resources 40 might be available to fulfill the service request.

At step 210, embodiments may determine a set of routes or detour routes for each mobile resource 40 needed to fulfill the service request. A first route or detour route may be a route between either an original route start point or the present location of the mobile resource 40 and the service request location. A second route or detour route may be a route between the service request location and either the original route endpoint or a point along the original route. Embodiments may determine a mobile resource 40 is available but that determining a route or a detour route is not feasible and remove the mobile resource 40 from the set of mobile resources 40.

At step 212, embodiments may determine a first detour time duration, a second detour time duration, and a service request location time duration needed to fulfill the service request. The first detour time duration may be the time needed to travel to the service request location from either an original route start point or the present location of the mobile resource 40. The second detour time duration may be the time needed to travel from the service request location to either the original route endpoint or a point along the original route. Embodiments may determine a mobile resource 40 is available but determine a first detour time duration, a second detour time duration, or the stopover location time duration is too long and remove the mobile resource 40 from the set of mobile resources 40.

At step 214, embodiments may determine a set of mobile resources 40 based on revenue, which may include determining revenue that may be earned by a specific mobile resource 40 for supplying the electric energy service minus the cost for that mobile resource 40 to provide the electric energy service (including fuel cost, operator time, travel expenses, etc.). Revenue may further be determined by subtracting any revenue that could be earned by the mobile resource delivering cargo.

At step 216, embodiments may determine a set of mobile resources 40 based on return on investment (ROI). For example, a mobile resource 40 may earn X dollars traveling to/from a location for a service request but earn 2X dollars for supplying electric energy service at the service request location. If the distance to the service request location is high, the ROI of dollars earned traveling to/from the service request location relative to the dollars earned for supplying electric energy service at the service request location may be below a minimum acceptable ROI.

At step 218, embodiments may determine a set of mobile resources 40 based on an incentive. An incentive may be provided by the customer 50, an agency, or a government. For example, an agency may provide incentives for supplying an energy service to keep a hospital or other critical infrastructure operating but not provide incentives for supplying an energy service to keep a hotel or other non-essential facilities operating.

At step 220, embodiments may communicate a resource request to each mobile resource 40 in a set of mobile resources 40. Communication may include providing each mobile resource 40 in the set of mobile resources 40 with one or more of an estimated revenue, an ROI, or an incentive to be earned by the mobile resource 40 fulfilling the service request. A resource request may provide options for the mobile resource 40, such as a service request location, a maximum time duration the mobile resource 40 can supply energy service, and a maximum detour time duration, as examples.

At step 222, embodiments determine if a resource request communicated to a mobile resource 40 is acceptable. Determining if a resource request is acceptable may include determining if a mobile resource 40 has sent a response or whether a response received from a mobile resource 40 includes an indication that the terms of the resource request are acceptable.

A resource request might not be acceptable because mobile resource 40 is carrying cargo that must be delivered within a time frame that does not allow for detours or delays associated with fulfilling a service request, an operator is near maximum operating hours, the mobile resource 40 is scheduled for maintenance, or some other reason. In some embodiments, mobile resource 40 and/or operations server 10 analyzes a resource request and responds that the terms of the resource request are not acceptable. For example, a controller in mobile resource 40 carrying cargo with a deadline may receive a resource request, determine the time needed for mobile resource 40 to deliver the cargo to its destination does not allow mobile resources 40 enough time to provide energy service to fulfill the service request and automatically respond with an indication the resource request is not acceptable.

If the resource request is not acceptable, embodiments may perform steps 208-222 until a resource request is acceptable to a set of mobile resources 40.

A resource request might be acceptable for various reasons including the mobile resource 40 and operator are not under any constraints that would prevent acceptance, or the revenue, ROI, or incentives are high. In some embodiments, a controller in mobile resource 40 and/or operations server 10 analyzes a resource request and responds that the terms of the resource request are acceptable. For example, a controller in mobile resource 40 may be configured to determine a return on investment (ROI) for each resource request and automatically accept any service request with an ROI greater than 2. Responses to resource requests may be received from multiple mobile resources 40, each with a response indicating a different estimated time of arrival, a different cost, a different rate at which electricity may be provided, a different length of time over which electric energy service may be provided, and other variations. A response to a resource request may include multiple options based on different criteria.

At step 224, if the resource request is acceptable, embodiments may respond to the service request with a set of price options. A price option may include the amount of electric energy service that can be supplied and the cost to supply the electric energy service, including any costs for fuel, labor, etc. A set of price options may include a first price option for a mobile resource 40 to respond within a very short time and a second price option corresponding to a longer time for a mobile resource 40 to respond, which allows more efficient assignment of a mobile resource 40 to fulfill the request. The set of price options may allow customer 50 to select a price or range of prices they agree to pay.

At step 226, embodiments determine if customer 50 has accepted a price option. Accepting a price option may comprise the customer selecting from a list of possible price options.

If the customer does not accept any price option, embodiments may perform steps 208-226 until a resource request is acceptable and the customer accepts.

If the customer accepts a price option, then at step 228, embodiments may send instructions to each mobile resource 40 in the set of mobile resources 40 needed to fulfill the service request. The instructions may include a route or a first detour route and a performance plan for operating the drivetrain over the first detour route such that the mobile resource 40 arrives at the service request location configured to supply energy service according to the energy service supply plan. The instructions may include an energy service supply plan for operating the drivetrain during the stopover such that mobile resource 40 supplies the energy service according to the energy service supply plan. The instructions may include a second route or detour route and a performance plan for operating the drivetrain over the second detour route such that the mobile resource 40 arrives at the destination. Each set of instructions may comprise a set of drivetrain configuration instructions and target values for a set of operating parameters for the drivetrain.

Responding to a Service Request with a Single Mobile Resource

FIG. 3 depicts a flow diagram illustrating a method 300 for selecting a single mobile resource to respond to a service request.

At step 302, embodiments receive a service request. Step 302 may be performed similarly to step 202 described above.

At step 304, embodiments determine how many mobile resources 40 are needed to fulfill the service request. Step 304 may be performed similarly to step 204 described above.

At step 306, embodiments determine if one mobile resource 40 can supply all the electric energy service requested.

If more than one mobile resource 40 is needed, then at step 308, embodiments may determine an aggregate of mobile resources 40 needed to fulfill the service request (discussed below).

If only one mobile resource 40 is needed, then at step 310, embodiments may determine a set of mobile resources 40 that might be available to fulfill the service request. Not every mobile resource is available to fulfill every service request. The set of mobile resources 40 available to fulfill the service request may include more mobile resources 40 than the number of mobile resources 40 needed to fulfill the service request to allow selection of a mobile resource 40 or set of mobile resources 40 best suited for fulfilling the service request. For example, embodiments may determine only one mobile resource 40 is needed to fulfill a service request but may identify multiple mobile resources 40 that may be available to fulfill the service request. Identifying a set of mobile resources 40 available to fulfill a service request allows embodiments to determine which mobile resource 40 (or mobile resources 40) may be preferred due to customer preference or mobile resource owner preference. For example, operations server 10 may communicate with cargo tracking server 16 to determine a mobile resource 40 is transporting cargo or is transporting cargo with a deadline and may determine the mobile resource 40 is not available.

In some embodiments, operations server 10 may communicate with mobile resource configuration server 14, engineering server 34, cargo tracking server 16 and mobile resources 40 to get information about mobile resources 40 and identify a mobile resource 40 for including in a set of mobile resources 40 that might be available to fulfill the service request. A mobile resource 40 might not be carrying cargo, a mobile resource 40 might be carrying cargo that has a flexible delivery time, a mobile resource 40 may have no scheduled maintenance immediately upcoming or may otherwise be added to the set of mobile resources 40 as being available for responding to a service request.

At step 312, embodiments determine a route or detour route for each mobile resource 40 in the set of mobile resources 40 to fulfill the service request. Determining a route or detour route for a mobile resource 40 may include determining the present location of the mobile resource 40 and a destination for the mobile resource 40. A present location may be associated with a warehouse or other location or may be determined based on an original route that mobile resource 40 is presently on or is expected to be on. For example, a mobile resource 40 may be traveling between a warehouse in Dallas to New Orleans along an original route that does not include passing through Houston and receive a resource request to supply electric energy service to a customer in Houston. Embodiments may determine a detour route for mobile resource 40 that begins in Dallas or somewhere along an original route between Dallas and New Orleans, wherein the detour route includes part of the original route but is modified to include Houston.

At step 314, embodiments determine a detour start and detour end for each mobile resource 40 in the set of mobile resources 40. Determining a detour start and detour end for a mobile resource 40 may include determining an original route for the mobile resource 40, determining a first detour route between the present location and a service request location and determining a second detour route for the mobile resource 40 between the service request location and a destination location. For example, if embodiments determine mobile resource 40 is traveling between a warehouse in Dallas to New Orleans along an original route that does not include passing through Houston, embodiments may determine a first detour route starts in Dallas or somewhere along the original route and ends at a service request location in Houston. Embodiments may determine a second detour route starts at the service request location in Houston and ends somewhere along the original route or in New Orleans.

At step 316, embodiments determine a cost for each mobile resource 40 in the set of mobile resources to fulfill the service request. The cost may include the cost for mobile resource 40 to travel over the original route, the first detour route or the second detour route, the operator cost associated with mobile resources 40 traveling over the first detour route and the second detour route, the cost of fuel, the rate at which electric energy service is generated or supplied, and other costs.

At step 318, embodiments respond to the service request with an estimated time of arrival of mobile resource 40 and a set of price options for mobile resource 40 to fulfill the service request. Each price option in the set of price options may include a cost estimate and may also include other adjustments related to fulfilling the service request.

At step 320, when customer 50 accepts a price option for fulfilling the service request, embodiments communicate a performance plan and energy service supply plan for the mobile resource 40 selected to fulfill the service request.

One or more of steps 302-320 may be performed by a processor on one or more mobile resources 40 or by a processor in operations server 10.

In some situations, more than one mobile resource 40 may be needed to fulfill a service request received from a customer. FIG. 4 depicts a flow diagram illustrating a method 400 for aggregating multiple mobile resources 40 to respond to a service request.

At step 402, embodiments receive a service request. Step 402 may be performed similarly to step 202 described above.

At step 404, embodiments determine how many mobile resources 40 are needed to fulfill the service request. Step 404 may be performed similarly to step 204 described above.

At step 406, embodiments determine if one mobile resource 40 can supply all the electric energy service requested.

If only one mobile resource 40 is needed, then at step 408, embodiments may identify a mobile resource 40 to fulfill the service request and perform steps according to FIG. 3.

If more than one mobile resource 40 is needed, then at step 410, embodiments determine a set of connection points to fulfill the service request. Each connection point has a corresponding location and embodiments may determine a location for each connection point. A connection point may be configured to receive energy service from a single mobile resource 40 or may be configured to receive energy service from multiple mobile resources 40. A connection point may be provided by a customer 50. A connection point may be determined based on ensuring a facility has electric energy service.

At step 412, embodiments determine the energy service capacity of each connection point. Each connection point may be able to receive electric energy service at a rate within a range of rates up to a maximum rate.

At step 414, embodiments identify a set of mobile resources 40 that may be available to fulfill the service request. Not every mobile resource is available to fulfill every service request. The set of mobile resources 40 may include more mobile resources 40 than the minimum number of mobile resources to allow the selection of a set of mobile resources 40 best suited for fulfilling the service request. For example, a mobile resource 40 might be unavailable if it is transporting cargo, transporting cargo with a deadline, traveling to a destination for maintenance, or some other reason. In some embodiments, operations server 10 may communicate with mobile resource configuration server 14, engineering server 34 and mobile resources 40 to get information about mobile resources 40 and communicate with cargo tracking server 16 to determine a set of mobile resources 40 that might be available to fulfill the service request. In some situations, the number of connection points may limit how many mobile resources 40 can supply electric energy service. For example, a service request may be for 1 MW and there may be enough mobile resources 40 to supply 1 MW of electric energy service but there may be only 25 connection points such that the set of mobile resources 40 must be 25 or fewer and the combined energy service supply capacity of the set of mobile resources 40 must be at least 1 MW. In other situations, the number of available mobile resources 40 or the combined electric supply capacity of the set of mobile resources 40 may be less than the request electric energy service. For example, fewer connection points may allow a set of mobile resources 40 to supply only 800 kW of electric energy service. Step 414 may include prioritizing a set of connection points and identifying a set of mobile resources 40 such that the combined energy service generating capacity of the set of mobile resources 40 can supply the requested electric energy service at the connection points.

At step 416, embodiments determine a set of routes or detour routes for each mobile resource 40 in the set of mobile resources 40.

Determining a first detour route for a mobile resource 40 may include determining an original route between an original route start point and an original route endpoint and determining a first detour route comprising a first portion between the original route start point and the service request location. Determining the first detour route for mobile resource 40 may include determining a second portion between the service request location and the original route endpoint.

Determining a second detour route for mobile resource 40 may include determining an original route between an original route start point and an original route endpoint, determining a present location of mobile resource 40, and determining a second detour route comprising a first portion between the present location of mobile resource 40 and the service request location. Determining the second detour route for mobile resource 40 may include determining a second portion of the second detour route between the service request location and the original route endpoint.

Determining a third detour route for mobile resource 40 may include determining an original route between an original route start point and an original route endpoint, determining a present location of mobile resource 40, and determining a third detour route comprising a first portion starting at a location along the original route between the present location of mobile resource 40 and the service request location and ending at the service request location. Determining the third detour route for mobile resource 40 may include determining a second portion of the third detour route between the service request location and a location between the service request location and the original route endpoint.

For example, a mobile resource 40 may be traveling between a warehouse in Dallas to New Orleans along an original route that does not include passing through Houston and receive a resource request to supply electric energy service to a customer in Houston. Embodiments may determine a first portion of a first detour route for mobile resource 40 begins at the original route start point in Dallas, a first portion of a second detour route begins at the present location of mobile resource 40 somewhere along an original route, and a first portion of a third detour route corresponds to a location somewhere along the original route, wherein the first portion of each of the first detour route, the second detour route and the third detour route end at a service request location in Houston. A second portion of each of the first detour route, the second detour route, and the third detour route may end at an original route endpoint in New Orleans or somewhere along the original route.

Determining a detour route for a mobile resource 40 may include determining a route based on ensuring the mobile resource 40 is capable of generating and supplying electric energy service to fulfill a service request. Determining a detour route for a mobile resource 40 may include determining a detour route based on a battery charge in a battery system on the mobile resource 40. Determining a detour route for a mobile resource 40 may include determining a detour route based on the amount of electric energy service that an engine on the mobile resource 40 is capable of generating to ensure the battery charge is at a minimum battery charge when mobile resource 40 reaches a connection point. Determining a detour route for a mobile resource 40 may include determining the cost of fuel necessary for the engine to generate electric energy service to supply to the battery system to the minimum battery charge. Determining a detour route for a mobile resource 40 may include determining the cost of the engine and/or battery system operating over the detour route such that the mobile resource 40 arrives at the connection point with the minimum battery charge and a minimum fuel level necessary for the engine to generate and supply electric energy service to fulfill a service request. Determining a detour route for a mobile resource 40 may include determining how much driver time is needed to reach a connection point. Determining a detour route for a mobile resource 40 may include determining other costs as well. For example, determining a detour route for a mobile resource 40 may include determining how much revenue is lost based on mobile resource 40 not delivering cargo.

At step 418, embodiments determine a detour start time, a detour end time, and a detour time duration for each detour route in the set of detour routes for each mobile resource 40.

At step 420, embodiments determine the cost to fulfill the service request. The cost may include the aggregated cost of providing multiple mobile resources 40, each mobile resource 40 supplying a specified amount of electric energy service at a specified rate, along with the cost for each mobile resource 40 to travel on a detour route to a specified connection point and remain at the connection point. Determining a cost may include determining a set of energy service supply plans for each mobile resource, wherein each energy service supply plan enables mobile resource 40 to generate, store and/or supply electric energy service and has a cost associated with one or more of generating, storing, and supplying electric energy service. Determining a cost may include determining a set of performance plans, wherein each performance plan is associated with mobile resource 40 traveling on a detour route to reach a connection point.

At step 422, embodiments respond to the service request with a set of price options for supplying electric energy service according to the service request. The set of price options may include, for example, a first price option for supplying electric energy service with a starting time within a minimum time of arrival, a second price option for supplying the same amount of electric energy service but with a later starting time, and a third price option for supplying the same amount of electric energy service but at a higher electric energy service generation rate.

At step 424, if customer 50 accepts a price option, embodiments communicate a resource request to each selected mobile resource 40, the resource request comprising one or more of a route for each mobile resource 40, a performance plan for each mobile resource 40 to travel on the detour route and an energy service supply plan for each mobile resource to generate, store and/or supply electric energy service to the customer.

Mobile Resources have Various Drivetrain Configurations

Route information may be the same for all mobile resources 40 traveling on the same route. However, different mobile resources 40 traveling on the same route can have different weights and drivetrain configurations such that no single performance plan may be possible for all mobile resources 40 traveling the same route. Similarly, different mobile resources 40 with different drivetrain components and configurations may be able to generate electric energy service to fulfill a service request but may do so with different drivetrain configurations executing different sets of instructions with different values for operating parameters.

Drivetrain configuration information for a mobile resource 40 may be retrieved from engineering server 34 and/or retrieved from the mobile resource 40. Drivetrain configuration information may include information about an engine, a transmission, a motor/generator, a battery system, an e-axle, and other components forming part of a drivetrain in the mobile resource 40. For example, drivetrain configuration information may include information about an engine such as the engine comprises an internal combustion engine with a 15-liter displacement that runs on diesel fuel. Engine information may further include an engine map or other information related to the energy service output and efficiency of the engine. Drivetrain configuration information for a transmission coupled to the engine may include information such as the number of gears, the gear ratio for each gear, and an efficiency of the transmission. Drivetrain configuration information for a M/G may include the output energy service capacity and an efficiency associated with the M/G operating as a motor, as well as the input/energy service capacity and an efficiency associated with the M/G operating as a generator. Drivetrain configuration information for a battery system may include information such as a battery chemistry, a maximum SOC of the battery system, a maximum discharge rate, a maximum charge rate, and a maximum operating temperature of the battery system. Drivetrain configuration information for an e-axle may comprise a rolling resistance of the e-axle.

Examples of engine types include an internal combustion (IC) engine (also referred to as an ICE) that may be configured to operate using gasoline, diesel, natural gas (NG) including compressed natural gas (CNG), liquid natural gas (LNG) and renewable natural gas (RNG), or other types of engines including, but not limited to gas turbines and fuel cells, which may operate on hydrogen, natural gas, propane or some other fuel source.

The drivetrain configuration information may include information such as how much energy service can be supplied by the engine and/or how much energy service can be supplied by a motor/generator (M/G) operating as a motor.

The drivetrain configuration information may include information about what type of battery system is installed in each mobile resource 40. Battery chemistry may differ between battery systems in mobile resources 40. The drivetrain configuration information may include information about the battery capacity for a battery system installed in each mobile resource 40. Improvements in battery chemistry and packaging may allow increased battery capacity.

The drivetrain configuration information may include information such as the state of an e-axle. The information may include whether the e-axle is in an up position or a down position.

Mobile resource configuration information may be stored in mobile resource information storage 24. In some embodiments, operations server 10 may communicate with engineering server 24 and/or mobile resources 40 to get mobile resource configuration information. For example, operations server 10 may communicate with engineering server 34 to get information about a type of battery in a particular mobile resource 40 and communicate with a particular mobile resource 40 to get information about fuel efficiency of that particular mobile resource 40 including a fuel efficiency associated with the engine providing only rotational energy service to the one or more axles, a fuel efficiency associated with the engine providing rotational energy service to the one or more axles and providing rotational energy service to a motor/generator to generate electric energy service and a fuel efficiency associated with the engine providing only rotational energy service to the motor/generator to generate electric energy service.

FIG. 5 depicts a flow diagram of a method 500 for selecting one or more mobile resources 40 of a set of mobile resources 40 for responding to a service request. Portions of method 500 may be performed by a system 100 for responding to a service request or may be performed by a controller installed in each mobile resource 40. For example, a system 100 for responding to a service request 40 may collect information from mobile resource 40 and determine a route or detour route, an energy service supply plan, and a performance plan for mobile resource 40 before mobile resource 40 starts traveling along an original route. As mobile resource 40 travels along the original route, the mobile resource 40 may communicate with operations server 10 to get a detour route and any updates to the performance plan. Performance of the mobile resource 40 may be fine-tuned to meet the needs of mobile resource 40 traveling on an original route or a detour route. For example, if a road surface on a detour route was recently resurfaced such that the rolling resistance has changed, a controller in mobile resource 40 may adjust the performance plan for mobile resource 40 on the detour route (and any mobile resources 40 subsequently traveling along the same road).

At step 502, embodiments determine a drivetrain configuration and present values of a set of operating parameters for mobile resource 40. Determining a drivetrain configuration may include determining whether an engine is operating, whether a motor is operating as a motor or a generator, whether batteries are charging or discharging, and whether an e-axle is in an up position or a down position.

At step 504, embodiments determine a mobile resource weight for mobile resource 40. Determining mobile resource weight may include determining a base weight (such as by accessing information stored in engineering server 34 or mobile resource information storage 24) and adding any cargo weight.

At step 506, embodiments determine target values for a set of operating parameters for mobile resource 40. Target values may include, for example a minimum battery SOC or a minimum fuel level based on supplying electric energy service in accordance with an energy service supply plan.

At step 507, embodiments determine a service request location.

At step 508, embodiments determine drivetrain configuration and target values for operating parameters of mobile resource 40 based on an energy service supply plan. For example, if an energy service supply plan requires mobile resource 40 to supply electric energy service while producing zero emissions, embodiments may determine a drivetrain configuration in which an engine is not operating, in which all electric energy to fulfill the service request is supplied from a battery system. Embodiments may determine target values for the battery system such that the battery system can supply the electric energy service.

At step 510, embodiments determine a cost to fulfill the service request using the energy service supply plan. Determining the cost may include determining the cost of fuel needed for an engine to convert fuel into electric energy service, determining a cost for driver time, and determining other costs.

At step 512, embodiments determine if the cost to fulfill the service request using the energy service supply plan is acceptable. If the amount of revenue to be earned from fulfilling the service request is less than the cost, responding to the service request might not be acceptable.

At step 514, if embodiments determine that the cost to fulfill the service request using the energy service supply plan is acceptable, embodiments determine drivetrain configuration and target values for operating parameters of mobile resource 40 based on a performance plan that will result in the present values of the set of operating parameters reaching a set of target values when mobile resource 40 reaches a service request location. For example, if a route or detour route requires mobile resource 40 to operate with zero emissions, embodiments may determine a performance plan with a drivetrain configuration in which an engine is not operating, in which all electric energy to fulfill the service request is supplied from a battery system. Embodiments may determine a performance plan for traveling on a route through a zero-emissions zone and for arriving at a service request location with target values for the battery system such that the battery system can supply the electric energy service.

For example, if mobile resource 40 is expected to travel along a detour route of twenty miles with a detour time duration of 30 minutes to reach a service request location with a minimum SOC of 50% (i.e., a target value), embodiments may determine a present SOC is 30% and calculate, based on the detour route, that mobile resource 40 will arrive with a SOC of 45%. Embodiments may then determine and communicate a performance plan for the mobile resource 40 with a set of drivetrain configuration instructions and values for operating parameters such that the mobile resource 40 arrives at the service request location with the value of the SOC at or above 50% SOC.

At step 516, embodiments determine a cost to fulfill the service request using the performance plan. Determining the cost may include determining a cost of fuel needed for an engine to propel mobile resource 40, a cost for the engine to convert fuel into an electric energy service, a cost for operator time, and other costs.

At step 518, embodiments determine if the cost to fulfill the service request using the performance plan is acceptable.

At step 520, if embodiments determine mobile resource 40 may operate according to the present drivetrain configuration and reach the service request location with target values for the set of operating parameters, embodiments may add mobile resource 40 to a filtered set of mobile resources 40.

At step 522, if embodiments determine mobile resource 40 cannot operate according to the present drivetrain configuration and reach the service request location with target values for the set of operating parameters, embodiments may remove mobile resource 40 from a filtered set of mobile resources 40. For example, if the amount of revenue to be earned from mobile resource 40 traveling to the service request location to fulfill the service request is less than the cost or the ROI for responding to the service request is below a threshold ratio, responding to the service request might not be acceptable.

At step 524, embodiments send a resource request to each mobile resource in the set of mobile resources 40.

Energy Service Supply Plan

An energy service supply plan may include a set of drivetrain configuration instructions and target values for a set of operating parameters for a mobile resource 40 to supply electric energy service to an external electric system. The energy service supply plan may be based on a total amount of electric energy service to be supplied or may be based on an energy service supply rate at which electric energy service is to be supplied and a time duration for supplying the electric energy service at the energy service supply rate or may be based on characteristics of the electric energy service. A characteristic of the electric energy service may be, for example, a voltage or frequency at which the electric energy service is supplied.

Energy Service Supply Plan Based on Ensuring Mobile Resource Supplies Electric Energy Service

FIG. 6 is a data structure 600 depicting example energy service supply plan information in table format. Using the methods described above with the data stored in one or more data structures described above, embodiments may determine an energy service supply plan (600) for each mobile resource 40.

An energy service supply plan may include a set of drivetrain configuration instructions and operating values for a set of operating parameters for a mobile resource 40 with a drivetrain comprising an engine, a M/G configurable as a motor or a generator, and a battery system. An energy service supply plan may comprise a set of drivetrain configuration instructions and a set of values for a set of operating parameters for multiple time periods. It should be noted that the length of time periods may vary. Thus, even if two mobile resources 40 are supplying electric energy service with the same characteristics, each mobile resource 40 may operate according to a different energy service supply plan.

Referring to FIG. 6, rows 604 consisting of rows 604-1 to 604-N refer to time periods and columns 602 consisting of columns 602-1 to 602-10 refer to drivetrain configuration instructions and values for operating parameters for a mobile resource 40. Row 604-1 refers to a first time period TimeID_1. Column 602-1 contains a value for identifying a time period (e.g., TIME ID_1). Column 602-2 contains a value for a start time (e.g., 2200) for Time_ID_1 and column 602-3 contains a value for an end time (e.g., 0600) for Time ID_1. Column 602-4 contains a drivetrain configuration instruction (e.g., OFF) for the engine such that the drivetrain for mobile resource 40 operates with the engine turned off for Time ID_1. Column 602-5 contains a value (e.g., 0 RPM) for an operating parameter of the engine for Time ID_1. Column 602-6 contains a drivetrain configuration instruction (e.g., OFF) for the M/G such that the drivetrain for mobile resource 40 operates with the M/G turned off for Time ID_1. Column 602-7 contains a value (e.g., 0) for an operating parameter of the M/G for Time ID_1. Column 602-8 contains a value (e.g., −100) for an operating parameter of the battery system, indicating the battery system is supplying electric energy service during Time ID_1. Column 602-9 contains a target value (e.g., 75) for an operating parameter of the battery system, indicating the battery system should be at 75% SOC at the end of Time ID_1. Column 602-10 contains a target value (e.g., 100) for an operating parameter of the drivetrain, indicating the drivetrain should deliver 100 kW/hour of electric energy service during Time ID_1.

Values for operating parameters may be a single value or a range of values. For example, referring to row 604-2 and column 602-5, a value of engine RPM may be specified as 1500 RPM for TimeID_2, whereas in row 604-3 and column 602-5, a value of engine RPM may be between 1800-2300 RPM for TimeID_3.

An energy service supply plan may specify which time periods a mobile resource 40 should operate an engine to generate rotational energy service (e.g., time periods TIME ID_2, TIME ID_3 and TIME ID_N) to supply to a M/G operating as a generator to generate electric energy service (e.g., battery energy service supplied from a battery system to operate a motor to drive the mobile resource 40), and which time periods (e.g., TIME ID_1) a mobile resource 40 should supply electric energy service from the battery system.

An energy service supply plan comprises a set of drivetrain configuration instructions and a set of values for a set of operating parameters associated with the mobile resource 40 supplying electric energy service. An energy service supply plan may comprise, for example, a drivetrain configuration instruction to operate an engine to supply rotational energy service to a M/G to generate electric energy service (and a battery system does not supply any electric energy service), or may comprise a set of drivetrain configuration instructions to operate the engine to supply rotational energy service to the M/G to generate electric energy service and the battery system also supplies electric energy service, or may comprise a set of drivetrain configuration instructions to not operate the engine such that the battery system supplies all the electric energy service. An energy service supply plan may include values for a set of operating parameters for mobile resource 40. For example, an energy service supply plan may comprise a total amount of electric energy service to be supplied or a rate at which electric energy service should be supplied, a value for a minimum rate at which electric energy service is to be supplied, a maximum rate at which electric energy service is to be supplied, an operating range for the engine, a maximum engine operating speed or a maximum generator speed.

Performance Plan

A performance plan may include a set of drivetrain configuration instructions and target values for a set of operating parameters for an engine, one or more M/Gs, a battery system and other drivetrain components based on mobile resource 40 traveling to the service request location. A drivetrain configuration instruction may comprise an instruction to turn an engine on or off, engage a M/G to the engine, disengage the M/G from the engine, turn the M/G on or off, operate the M/G as a motor, operate the M/G as a generator, allow the battery system to charge, allow the battery system to discharge, and to cool the battery system.

Engine operating parameters may include an engine operating range, an engine operating efficiency and a maximum engine operating speed, for example. M/G operating parameters may include a motor operating range, a motor operating efficiency, a maximum motor operating speed, a range of generator operating speeds, a generator efficiency, and a maximum rate of generator operation, for example. Battery operating parameters may include a range of battery charging, a maximum battery charging rate, a range of battery discharge rates, a maximum battery discharge rate, a minimum battery state of charge, a maximum battery state of charge and a maximum battery operating temperature. A set of operating parameters may include more or fewer operating parameters. A performance plan communicated to a mobile resource 40 such as a wheeled vehicle may provide target values for operating parameters but still allow a driver to drive the mobile resource 40 based on actual road conditions, traffic, visibility, weather, and other safety concerns. For example, a speed limit over a route may be 65 miles per hour and a mobile resource 40 may be traveling over the route at 45 miles per hour because the driver has determined it is not safe to travel at 65 miles per hour (there may be bad weather, poor visibility, an accident, road maintenance, etc.) Embodiments may determine and communicate a performance plan for the mobile resource 40 for reaching a destination with target values for a set of operating parameters for the mobile resource 40 based on the current mobile resource speed, but do not send any instructions to accelerate the mobile resource 40.

Performance Plans Sent to Different Vehicles are Based on Ensuring Each Vehicle Drivetrain is Capable of Completing its Intended Route

FIG. 7 is a data structure 700 depicting example vehicle performance plan information in table format. Using the methods described above with the data stored in one or more data structures described above, embodiments may determine a performance plan (700) for each mobile resource 40.

A performance plan may specify a set of operating parameters for a mobile resource 40 with a particular configuration comprising an engine, two M/Gs configurable as a motor or a generator, and a battery system. A performance plan may comprise a set of drivetrain configuration instructions and a set of values for a set of operating parameters for each segment. A performance plan may specify which segments a mobile resource 40 should use an engine to generate rotational power to drive the mobile resource 40 (e.g., segments 704-1 and 704-N), which segments a mobile resource 40 should use a motor as a motor to supply rotational power to the e-axle (e.g., segments 704-2 and 704-N), which segments a mobile resource 40 should use a motor as a generator to capture regenerated power, which segments a mobile resource 40 should use battery power supplied from a battery system to operate a motor to drive the mobile resource 40, which segments a mobile resource 40 should use battery power supplied from a battery system to operate a motor, which segments a mobile resource 40 should use regenerative braking to charge a battery system, which segments a mobile resource 40 should use regenerative braking to charge a battery system and brake, which segments a mobile resource 40 should coast, and which segments a mobile resource 40 should operate to cool the battery system. In some embodiments, a performance plan 700 may specify a value for an engine operating parameter including a vehicle speed range or a maximum vehicle speed, a motor operating parameter or a range of motor operating parameters, a generator operating parameter or a range of generator operating parameters, a battery state of charge (SOC), a minimum battery SOC at the beginning or end of a segment, a maximum battery SOC at the beginning or end of a segment, a maximum rate of charging the battery system, a minimum fuel level at the beginning or end of the segment, a minimum fuel efficiency while operating in the segment, a maximum emission output while operating in the segment or some other operating parameter.

As depicted in FIG. 7, rows 704 (consisting of rows 704-1 to 704-N) may be associated with segments, wherein each row 404 has a value corresponding to a segment identifier column 702-1, a value corresponding to a grade column 702-2, a drivetrain configuration instruction corresponding to an engine state column 702-3, a value corresponding to an engine operating parameter column 702-4, a drivetrain configuration instruction corresponding to a M/G state column 702-5, a value corresponding to M/G operating parameter column 702-6, a drivetrain configuration instruction corresponding to an e-axle state column 702-7, a value corresponding to a battery SOC operating parameter column 702-8, a value corresponding to a battery SOC target operating parameter column 702-9, and a value corresponding to a battery temperature operating parameter column 702-10.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method of responding to a service request for electric energy service, the method comprising:
receiving a service request for electric energy service over a network;
determining a number of mobile resources needed to fulfill the service request;
identifying one or more mobile resources available to fulfill the service request from a plurality of mobile resources;
selecting one or more mobile resources from the identified one or more mobile resources to fulfill the service request; and
communicating, to each selected mobile resource, a route to travel to a service request location, a performance plan to manage operation of a drivetrain to travel to the service request location, and an energy service supply plan to manage operation of the drivetrain to supply the electric energy service at the service request location to fulfill the service request.

2. The method of claim 1, wherein:
the service request comprises one or more of an amount of the electric energy service to be supplied, a rate at which the electric energy service is to be supplied, a time duration during which the electric energy service is to be supplied and a characteristic of the electric energy service and one or more of a customer identification, the service request location, and a time; and
determining the number of mobile resources comprises determining a mobile resource capable of supplying the electric energy service based on one or more of the amount of electric energy service, the rate at which the electric energy service is to be supplied, the time duration during which the electric energy service is to be supplied and the characteristic of the electric energy service.

3. The method of claim 1, wherein the plurality of mobile resources comprises at least one of a hybrid electric truck, a hybrid electric truck/trailer combination, a fully electric truck, or a fully electric truck/trailer combination.

4. The method of claim 1, further comprising determining a price option for the identified one or more mobile resources to fulfill the service request, wherein determining the price option comprises determining one or more of an amount of revenue, a return on investment (ROI), and an incentive to responding to the service request.

5. The method of claim 4, wherein determining the price option for the identified one or more mobile resources to fulfill the service request comprises:
for each mobile resource of the identified one or more mobile resources:
determining a set of detour routes to travel to the service request location;
determining a revenue associated with the mobile resource traveling to the service request location for each detour route of the set of detour routes;
determining a return on investment (ROI) associated with the mobile resource traveling to the service request location for each detour route of the set of detour routes; and
determining an incentive associated with the mobile resource traveling to the service request location for each detour route of the set of detour routes.

6. The method of claim 5, wherein determining the set of detour routes for each mobile resource of the identified one or more mobile resources comprises:
determining an original route for the mobile resource between an original route start point and an original route endpoint;
determining a present location of the mobile resource;
determining a first portion of a first detour route with a first detour route start point corresponding to the original route start point;
determining a first portion of a second detour route with a second detour route start point corresponding to the present location of the mobile resource; and
determining a first portion of a third detour route with a third detour route start point between the present location of the mobile resource and the service request location.

7. The method of claim 5, wherein determining the revenue for each detour route in the set of detour routes comprises:
determining a first amount of revenue for supplying electric energy service at the service request location; and
for each detour route:
determining a second amount of revenue for traveling over the detour route; and
adding the first amount of revenue to the second amount of revenue.

8. The method of claim 5, wherein determining a return on investment for each detour route in the set of detour routes comprises:
determining a first time duration for supplying electric energy service at the service request location;
for each detour route:
determining a second time duration for traveling over the detour route; and
dividing the first time duration by the second time duration.

9. The method of claim 4, wherein the incentive comprises one or more of:
a revenue or cost reduction earned for responding to the service request within a specified time duration;
a revenue or cost reduction earned for supplying an amount of electric energy service more than a threshold amount specified in the service request;
a revenue or cost reduction earned for supplying electric energy service at a rate greater than a threshold rate specified in the service request; and
a revenue or cost reduction earned for supplying electric energy service for a time duration longer than a threshold time duration specified in the service request.

10. The method of claim 1, wherein communicating to each selected mobile resource, the performance plan for the selected mobile resource to travel to the service request location comprises:
determining a present location of the mobile resource;
determining a plurality of segments for a route to travel from the present location of the mobile resource to the service request location;
for each segment:
determining a set of starting values for a set of operating parameters for the mobile resource, the set of starting values comprising a starting state of charge (SOC) for a battery system and a starting fuel quantity at a start of the segment;
determining a starting drivetrain configuration of the mobile resource;
determining a set of target values for the plurality of operating parameters, the set of target values comprising a target SOC for the battery system and a target fuel quantity at an end of the segment;
calculating, based on the set of starting values and the starting drivetrain configuration, a set of predicted end values for the plurality of operating parameters, the set of predicted end values comprising a predicted end SOC of the battery system and a predicted fuel quantity at the end of the segment; and
determining one or more predicted end values of the set of predicted end values will be less than one or more target values of the set of target values; and
communicating the performance plan comprising the set of target values for the set of operating parameters and a set of drivetrain configuration instructions to change the drivetrain configuration.

11. The method of claim 10, further comprising changing a configuration of a drivetrain in a selected mobile resource in response to the set of drivetrain configuration instructions received at the selected mobile resource.

12. The method of claim 10, wherein communicating to each selected mobile resource, the performance plan for the selected mobile resource to travel to the service request location comprises:
determining the predicted end SOC of the battery system will be less than a target SOC of the battery system; and
communicating the performance plan comprising the set of drivetrain configuration instructions to change the drivetrain configuration to charge the battery system and the set of target values for the set of operating parameters comprises the target SOC for the battery system.

13. The method of claim 10, wherein communicating to each selected mobile resource, the performance plan for the selected mobile resource to travel to the service request location comprises:
determining the predicted fuel quantity will be less than the target fuel quantity; and
communicating the performance plan comprising the set of drivetrain configuration instructions to change the drivetrain configuration to not operate an engine over the segment and supply electric energy service from the battery system to a motor/generator to propel the mobile resource on the segment.

14. The method of claim 1, further comprising:
filtering the identified one or more mobile resources available to fulfill the service request to identify a set of mobile resources to respond to the service request;
communicating a resource request to each mobile resource in the set of mobile resources;
receiving a response from at least one mobile resource in the set of mobile resources;
determining a set of price options for the at least one mobile resource to fulfill the service request, comprising:
determining a set of detour routes for a mobile resource in the set of mobile resources to travel to the service request location; and
determining a price option based on a cost associated with the mobile resource traveling to the service request location for each detour route; and
communicating the set of price options to a customer over the network.

15. The method of claim 1, wherein determining the number of mobile resources comprises comparing an amount, rate, or duration of electrical energy service supply in the service request to an amount of electrical energy service supply available from a fleet of mobile resources.

16. The method of claim 1, wherein identifying the one or more mobile resources available to fulfill the service request comprises:
determining the service request location; and
determining a proximity of available mobile resources to the service request location.

17. The method of claim 1, further comprising supplying the electric energy service at the service request location via the selected one or more mobile resources according to the energy service supply plan.

18. A system for responding to a service request for electric energy service, the system comprising:
an operations server executing instructions to:
receive the service request over a network;
determine a number of mobile resources needed to fulfill the service request;
identify at least one mobile resource available to fulfill the service request;
select one or more mobile resources from the at least one mobile resource to fulfill the service request based on a selected price option; and
communicate, to each mobile resource of the selected one or more mobile resources, a route to travel to a service request location, a performance plan to manage operation of a drivetrain to travel to the service request location, and an energy service supply plan to supply the electric energy service at the service request location.

19. The system of claim 18, wherein the energy service request comprises one or more of an amount of the electric energy service to be supplied, a rate at which the electric energy service is to be supplied, a time duration during which the electric energy service is to be supplied, and a characteristic of the electric energy service and one or more of a customer identification, the service request location, and an energy service, wherein the operations server stores instructions executable to determine the number of mobile resources capable of supplying electric energy service based on one or more of the amount of the electric energy service, the rate at which the electric energy service is to be supplied, the time duration during which the electric energy service is to be supplied and the characteristic of the electric energy service.

20. The system of claim 18, wherein the operations server executes instructions to determine one or more of an amount of revenue, a return on investment (ROI), and an incentive to responding to the service request.

21. The system of claim 20, wherein the operations server stores instructions executable to:
for each mobile resource of the identified at least one mobile resource:
determine a revenue associated with the mobile resource traveling to the service request location for each detour route of a set of detour routes;
determine a return on investment (ROI) associated with the mobile resource traveling to the service request location for each detour route of the set of detour routes; and
determine an incentive associated with the mobile resource traveling to the service request location for each detour route of the set of detour routes.

22. The system of claim 21, further comprising a route planning server communicatively coupled to the operations server, wherein the route planning server stores instructions executable to:
for each mobile resource of the identified at least one mobile resource:
communicate with the operations server to get an original route start point and an original route endpoint;
determine an original route for the mobile resource between the original route start point and the original route endpoint;
determine a present location of the mobile resource;
determine a first portion of a first detour route with a first detour route start point corresponding to the original route start point;
determine a first portion of a second detour route with a second detour route start point corresponding to the present location of the mobile resource; and
determine a first portion of a third detour route with a third detour route start point between the present location of the mobile resource and the service request location.

23. The system of claim 21, wherein, to determine the revenue for each detour route in the set of detour routes, the operations server executes instructions to:
determine a first amount of revenue for supplying electric energy service at the service request location; and
for each detour route:
determine a second amount of revenue for traveling over the detour route; and
add the first amount of revenue to the second amount of revenue.

24. The system of claim 21, wherein, to determine the return on investment for each detour route in the set of detour routes, the operations server executes instructions to:
determine a first time duration for supplying electric energy service at the service request location; and
for each detour route:
determine a second time duration for traveling over the detour route; and
divide the first time duration by the second time duration.

25. The system of claim 20, wherein, to determine an incentive, the operations server executes instructions to:
determine a revenue or cost reduction earned for responding to the service request within a specified time duration;
determine a revenue or cost reduction earned for supplying an amount of electric energy service more than a threshold amount specified in the service request;
determine a revenue or cost reduction earned for supplying electric energy service at a rate greater than a threshold rate specified in the service request; and
determine a revenue or cost reduction earned for supplying electric energy service for a time duration longer than a threshold time duration specified in the service request.

26. The system of claim 18, wherein, to communicate the performance plan to each mobile resource of the selected one or more mobile resources:
a route planning server executes instructions to:
determine a present location of the mobile resource; and
determine, for each detour route of a set of detour routes, a plurality of segments for the detour route;
for each segment, a mobile resource configuration server communicatively coupled to the operations server executes instructions to:
determine a set of starting values for a set of operating parameters for the mobile resource, the set of starting values comprising a starting state of charge (SOC) for a battery system and a starting fuel quantity at a start of the segment;
determine a starting drivetrain configuration of the mobile resource;
determine a set of target values for the set of operating parameters, the set of target values comprising a target SOC for the battery system and a target fuel level at an end of the segment;
calculate, based on the set of starting values and the starting drivetrain configuration, a set of predicted end values for the set of operating parameters, the set of predicted end values comprising a predicted end SOC of the battery system and a predicted fuel quantity at the end of the segment; and
determine one or more predicted end values of the set of predicted end values will be less than one or more target values of the set of target values;
wherein the operations server communicates the performance plan comprising the set of target values for the set of operating parameters and a set of drivetrain configuration instructions to change the drivetrain configuration.

27. The system of claim 18, wherein the operations server stores instructions executable to:
filter the identified at least one mobile resource available to fulfill the service request to identify a set of mobile resources to respond to the service request;
communicate a resource request to each mobile resource in the set of mobile resources;
receive a response from at least one mobile resource in the set of mobile resources;
determine a set of price options for the at least one mobile resource to fulfill the service request, comprising:
determine a set of detour routes for a mobile resource in the set of mobile resources to travel to the service request location; and
determine a price option based on a cost associated with the mobile resource traveling to the service request location for each detour route; and
communicate the set of price options to a customer over the network.

28. The system of claim 18, wherein to determine the number of mobile resources, the operations server executes instructions to compare an amount, rate, or duration of electrical energy service supply in the service request to an amount of electrical energy service supply available from a fleet of mobile resources.

29. The system of claim 18, wherein to identify at least one mobile resource available to fulfill the service request, the operations server executes instructions to:
determine the service request location; and
determine a proximity of available mobile resources to the service request location.
